(19) United States
(12) Patent Application Publication
(10) Pub. No.: US 2012/0206537 A1
(43) Pub. Date: Aug. 16, 2012

(54) LIQUID EJECTION APPARATUS

(75) Inventors: Kosuke NUKUI, Nagoya-shi (JP); Shingo HATTORI, Nagoya-shi (JP)

(73) Assignee: BROTHER KOGYO KABUSHIKI KAISHA, Nagoya-shi (JP)

(21) Appl. No.: 13/356,531

(22) Filed: Jan. 23, 2012

(30) Foreign Application Priority Data
Feb. 10, 2011 (JP) 2011-027085

(51) Int. Cl. B41J 2/165

(52) U.S. Cl. 347/32

(57) ABSTRACT

A capping mechanism, which causes an ejection space opposing ejection openings of a liquid ejection head to take either one of a sealed state and a non-sealed state, includes an annular component which surrounds the ejection space in the sealed state and an opposing member which opposes the ejection openings with the ejection space interposed therebetween. A mechanism for supplying humidified air generates humidified air and includes a supply opening and a discharging opening. The supply opening and the discharging opening are positioned to form a humidifying passage such that the humidified air having flown along an inner circumferential surface of a first region of the annular component passes through a gap between the ejection openings and the opposing member and flows along an inner circumferential surface of a second region of the annular component, which opposes the first region.

### CROSS REFERENCE TO RELATED APPLICATION

The present application claims priority from Japanese Patent Application No. 2011-27085, which was filed on Feb. 10, 2011, the disclosure of which is herein incorporated by reference in its entirety.

### BACKGROUND OF THE INVENTION

1. Field of the Invention

The present invention relates to a liquid ejection apparatus which ejects liquid through ejection openings to record an image on a recording medium.

2. Description of the Related Art

A liquid ejection apparatus includes a head having an ejection surface on which ejection openings through which liquid such as ink is ejected are formed. When no liquid is ejected through the ejection opening for a long period, the moisture of the liquid around the ejection openings is evaporated and hence the viscosity is increased, with the result that the ejection openings are clogged.

The technology to restrain the clogging of the ejection openings is arranged so that an ejection space separated from the external space is formed by entirely covering the ejection surface by a concave capping member. According to the technology, by an air conditioner having an airflow passage provided with an air supply opening and an air discharging opening both made through the bottom surface of the capping member, humidified air is supplied into the ejection space through the air supply opening and the air in the ejection space is discharged through the air discharging opening. As such, the liquid around the ejection openings is humidified. The evaporation of the liquid around the ejection openings is restrained in this manner, and hence the clogging of the ejection openings is restrained.

### SUMMARY OF THE INVENTION

The above-described technology, however, is arranged so that the air supply opening and the air discharging opening are not formed at the respective edges of the bottom surface of the capping member. That is to say, in the ejection space is provided a humidifying passage in which humidified air flows from the air supply opening to the air discharging opening via the ejection surface. Since this passage does not reach the edges of the capping member, it is not possible to humidify, by the humidified air, the liquid adhering to an annular component which is a part of the capping member and abuts against the ejection surface. For this reason, once the circulation of the humidified air is stopped, thickened liquid which is not humidified and piles up on the annular component and its vicinity absorbs moisture from the liquid around the ejection openings, with the result that the liquid around the ejection openings are thickened and the ejection openings are clogged.

An object of the present invention is to provide a liquid ejection apparatus in which the thickening of liquid piling up on an annular component and its vicinity is restrained.

A liquid ejection apparatus of the present invention includes: a liquid ejection head having ejection openings for ejecting liquid; a capping mechanism which causes an ejection space opposing the ejection openings to take either one of a sealed state in which the ejection space is separated from an external space and a non-sealed state in which the ejection space is connected to the external space, the capping mechanism including an annular component which surrounds the ejection space in the sealed state and an opposing member which opposes the ejection openings with the ejection space interposed therebetween; a mechanism for supplying humidified air, which generates humidified air and includes a supply opening through which the humidified air is supplied into the ejection space separated from the external space by the capping mechanism and a discharging opening through which air is discharged from the ejection space; and a control unit which controls the capping mechanism so that the ejection space takes either one of the sealed state and the non-sealed state and controls the mechanism for supplying humidified air so that the humidified air is supplied to the ejection space in the sealed state through the supply opening and the humidified air is discharged through the discharging opening, the supply opening and the discharging opening being positioned to form a humidifying passage such that the humidified air having flown along an inner circumferential surface of a first region of the annular component passes through a gap between the ejection openings and the opposing member and flows along an inner circumferential surface of a second region of the annular component, which opposes the first region.

### BRIEF DESCRIPTION OF THE DRAWINGS

Other and further objects, features and advantages of the invention will appear more fully from the following description taken in connection with the accompanying drawings in which:

FIG. 1 is a schematic profile of the internal structure of an inkjet printer which is an embodiment of the liquid ejection apparatus of the present invention.

FIG. 2 is a plan view showing a passage unit and an actuator unit in the inkjet head of the printer of FIG. 1.

FIG. 3 is an enlarged view of the region III which is enclosed by a dashed line in FIG. 2.

FIG. 4 is a partial cross section of FIG. 3 taken along the IV-IV line.

FIG. 5 is a schematic view showing a head holder and a mechanism for supplying humidified air in the printer of FIG. 1.

FIG. 6A is a partial cross section of the region VI enclosed by a dashed line in FIG. 5, showing a state in which the cap is at a separated position. FIG. 6B is also a partial cross section of the region VI, showing a state in which the cap is at an abutting position.

FIG. 7 is a cross section of FIG. 5 taken along the VII-VII line.

FIG. 8 is a block diagram showing the electric configuration of the printer.

FIG. 9 is a flowchart of capping and humidifying maintenance operations controlled by a control unit of the printer.

FIG. 10 is a schematic view concerning the first variation of the liquid ejection apparatus of the embodiment of the present invention, showing the humidifying maintenance operation carried out in the sealed state.

FIG. 11 is a schematic view concerning the second variation of the liquid ejection apparatus of the embodiment of the present invention, showing the humidifying maintenance operation carried out in the sealed state.

FIG. 12 is a schematic view concerning the third variation of the liquid ejection apparatus of the embodiment of the present invention, showing the humidifying maintenance operation carried out in the sealed state.

### DESCRIPTION OF THE PREFERRED EMBODIMENTS

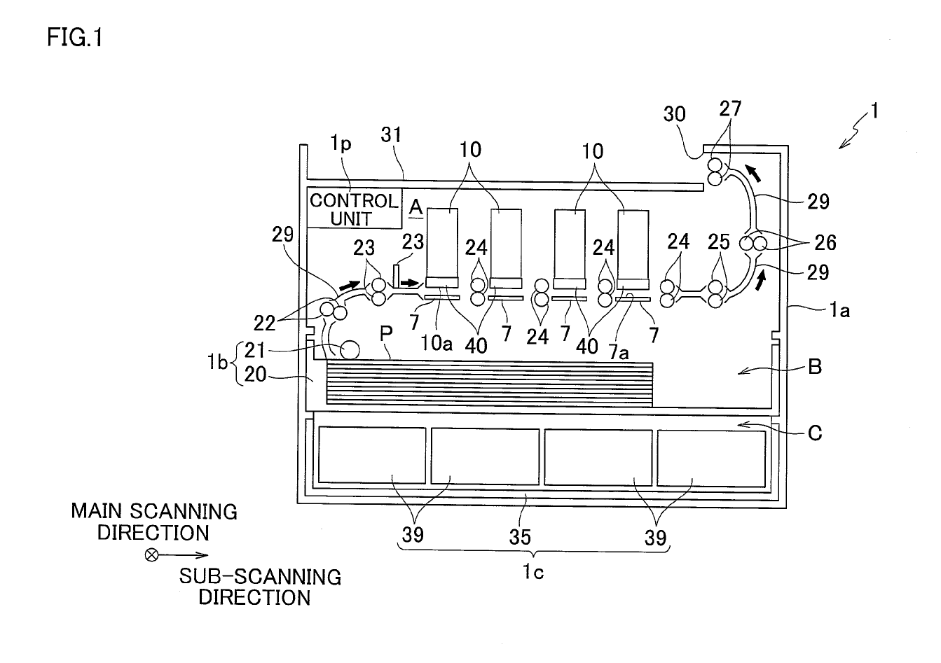

Referring to FIG. 1, the overall configuration of an inkjet printer 1 which is an embodiment of the liquid ejection apparatus of the present invention will be described.

The printer 1 has a rectangular parallelepiped chassis 1a. On the top plate of the chassis 1a is provided a sheet discharge section 31. The internal space of the chassis 1a is divided into spaces A, B, and C sequentially from the top. The spaces A and B have therein a sheet conveyance passage connecting a sheet supply unit 1b with the sheet discharge section 31. In the space A, image formation on a sheet P and transportation of the sheet P to the sheet discharge section 31 are carried out. In the space B, the sheet P is supplied to the conveying passage. In the space C, ink is supplied to heads 10 in the space A.

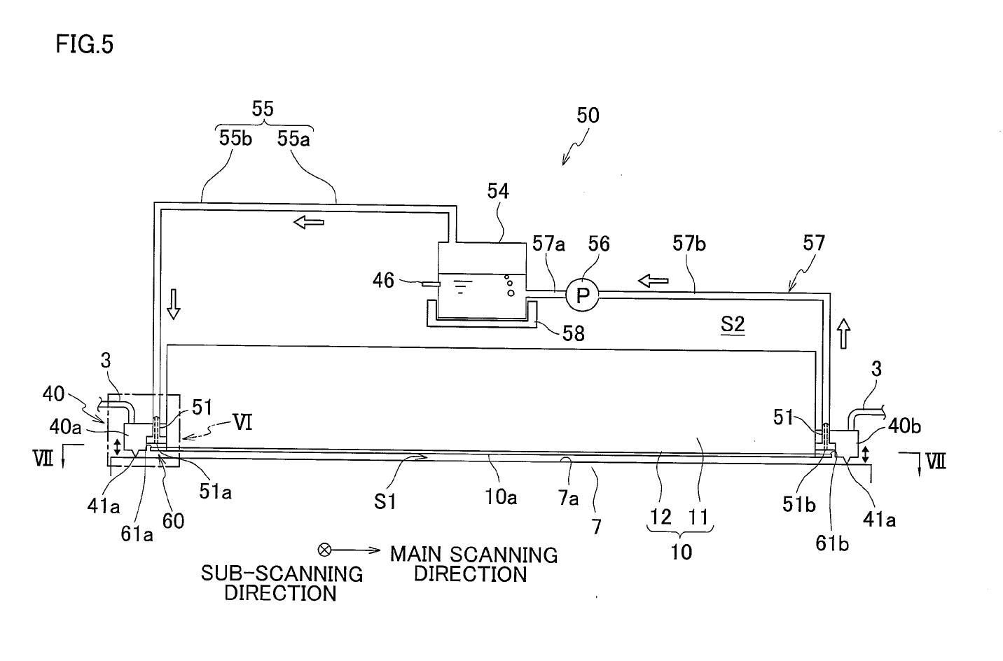

In the space A are provided components such as a sheet sensor 32, four heads 10, a transportation unit, guide units 29 which guide sheets P, a mechanism 50 for supplying humidified air (see FIG. 5) used for humidifying maintenance, and a control unit 1p. The transportation unit is constituted by four flat platens 7 opposing the four heads 10, respectively, and four feed roller pairs 24 provided along the sheet conveyance passage, and transports a sheet P in the direction indicated by thick arrows in FIG. 1 (i.e., in a conveyance direction).

Each head 10 is substantially rectangular parallelepiped and is long in the main scanning direction. The heads 10 are aligned in the sub-scanning direction at predetermined intervals, and are supported by the chassis 1a via head holders 3 (see FIG. 5). The head holders 3 support the heads 10 so that a predetermined gap suitable for recording is formed between an ejection surface 10a which is the lower surface of each head 10 and an opposing surface 7a which is the upper surface of the platen 7. The head holders 3 are provided with, for the respective heads 10, caps 40 which are annular components and disposed around the lower ends of the heads 10. Each cap 40 encloses the head 10 therein in plan view and surrounds the ejection surface 10a. The configuration, operation, function or the like of the caps 40 will be discussed later.

The guide units 29 are provided to sandwich the transportation unit. The guide unit 29 on the upstream in the conveyance direction includes a guide and two feed roller pairs 22 and 23, and connects a sheet supply unit 1b (described later) with the transportation unit. A sheet P for image formation is transported toward the transportation unit. The guide unit 29 on the downstream has a guide and three feed roller pairs 25 to 27, and connects the transportation unit with the sheet discharge section 31. The sheet P after image formation is transported toward the sheet discharge section 31.

In the space B is provided the sheet supply unit 1b. The sheet supply unit 1b includes a sheet feeding tray 20 and a pickup roller 21. The sheet feeding tray 20 is arranged to be detachable to the chassis 1a. The sheet feeding tray 20 is an open-top box and capable of housing a plurality of sheets P therein. The pickup roller 21 sends out the topmost sheet P housed in the sheet feeding tray 20. A sub-scanning direction is in parallel to the sheet conveyance direction in which sheets are transported by the feed roller pairs 23 and 24, whereas a main scanning direction is in parallel to the horizontal plane and orthogonal to the sub-scanning direction.

In the space C is provided a cartridge unit 1c which is arranged to be detachable to the chassis 1a. The cartridge unit 1c has a tray 35 and four cartridges 39 aligned in the tray 35. The four cartridges 39 store magenta, cyan, yellow, and black inks, respectively. Each cartridge 39 is connected to a head 10 via an unillustrated tube to supply ink having the corresponding color to the head 10.

Now, the control unit 1p will be described. The control unit 1p controls the components of the printer 1 and the overall operation of the printer 1. The control unit 1p controls an image formation operation based on image data supplied from an external apparatus (e.g., a PC connected to the printer 1). More specifically, the control unit 1p controls a preparation operation concerning recording, operations of supplying, transporting, and discharging sheets P, an ink ejection operation in sync with the transportation of sheets P, or the like. Furthermore, the control unit 1p controls the maintenance operation for the heads 10.

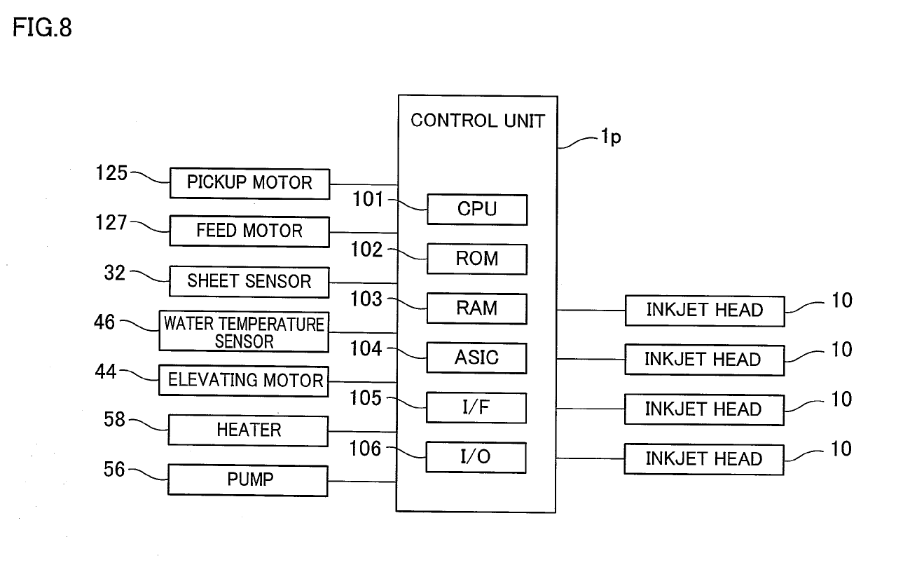

The control unit 1p drives, based on a recording instruction supplied from the external apparatus, a pickup motor 125 (see FIG. 8) for the pickup roller 21, a feed motor 127 (see FIG. 8) for the feed roller pairs 22 to 27, or the like. A sheet P sent out from the sheet feeding tray 20 is guided by the upstream guide unit 29 and sent to the transportation unit. In the transportation unit, the sheet P is transported while being supported by the opposing surfaces 7a of the platens 7 one by one. When the sheet P moves in the sub-scanning direction (sheet conveyance direction) and reaches the position immediately below each head 10, ink is ejected from the ejection surface 10a under the control of the control unit 1p, with the result that a color image is formed on the sheet P. The ink discharging operation is conducted based on a detection signal output from a sheet sensor 32 which detects the leading end of the sheet P. The sheet P on which the image has been formed is guided by the downstream guide unit 29, and is then discharged to the sheet discharge section 31 through an opening 30 made through an upper portion of the chassis 1a.

The control unit 1p conducts the maintenance operation to recover or maintain the ink ejection property of the head 10 and to carry out preparation for recording. The maintenance operation includes an ink ejection operation by purging and flushing, a cleaning operation to clean the ejection surface 10a by wiping, and a thickening prevention operation to prevent ink from being thickened by capping and humidification.

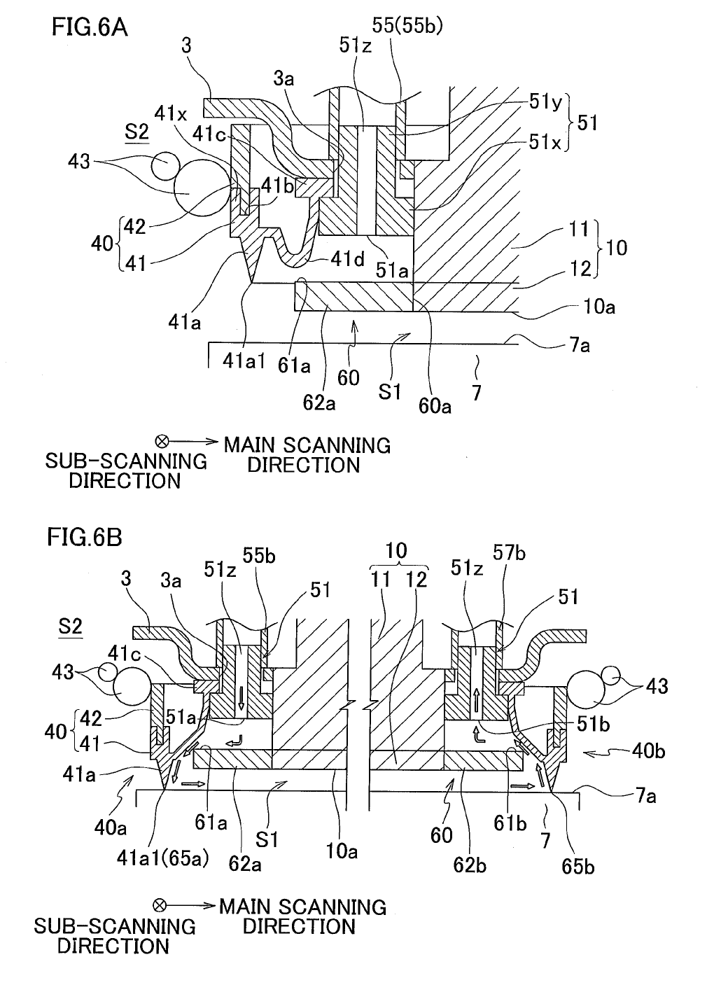

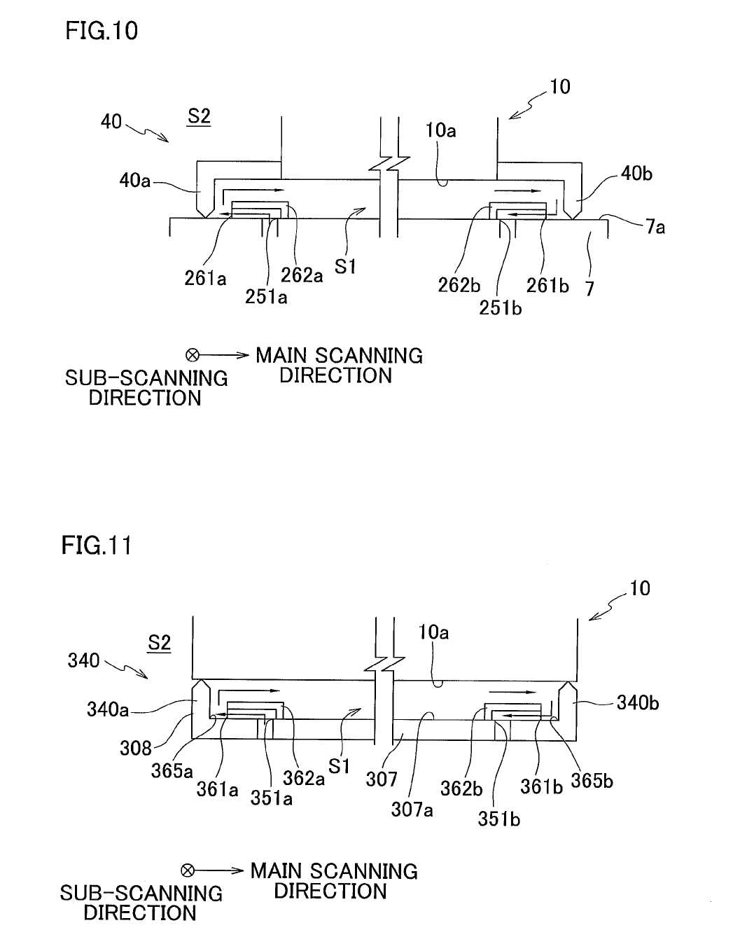

In the purging, a pump is driven so that ink is forcibly ejected through all ejection openings 14a. In the flushing, an actuator is driven so that ink is ejected through all ejection openings 14a. The ink ejection is conducted based on flushing data which is different from the image data. In the wiping, the ejection surface 10a is wiped by a wiper blade which is a plate-shaped elastic member. The wiping is conducted after the ink ejection operation, to remove residual ink and foreign matters on the ejection surface 10a. In the capping, as shown in FIG. 6B, the cap 40 separates the ejection space S1 opposing the ejection surface 10a from the external space S2. In the humidifying maintenance in the thickening prevention operation, as shown in FIGS. 10 to 12 in addition to FIG. 6B, humidified air is supplied to the separated ejection space S1.

The ink ejection operation is accompanied with the cleaning operation, and foreign matters in the head 10 and the thickened ink around the ejection openings 14a are ejected. The ejection surface 10a is cleaned as the ejection property of the ejection openings 14a is recovered. The capping restrains the drying of the meniscus, and the drying is further restrained by humidification. This ink ejection operation is conducted, for example, immediately after turning on the power of the printer 1, at the time of paper jam on the conveying passage, after image formation continued for at least a predetermined time, or after non-ejection for at least a predetermined time. The ink ejection operation (flushing in particular) immediately after turning on the power source is a preparation operation related to the recording. The operation to prevent ink from being thickened is conducted when the printer 1 is stopped or on standby.

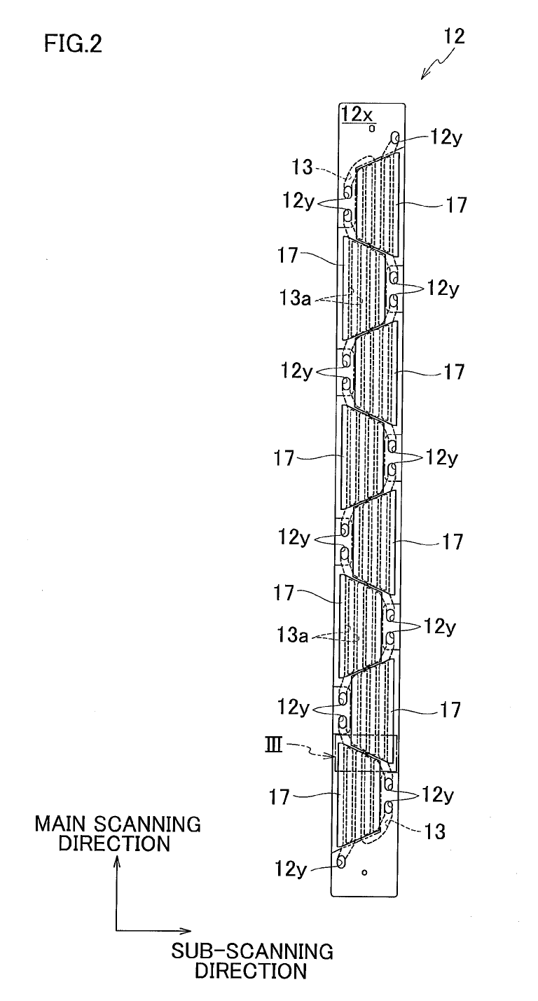

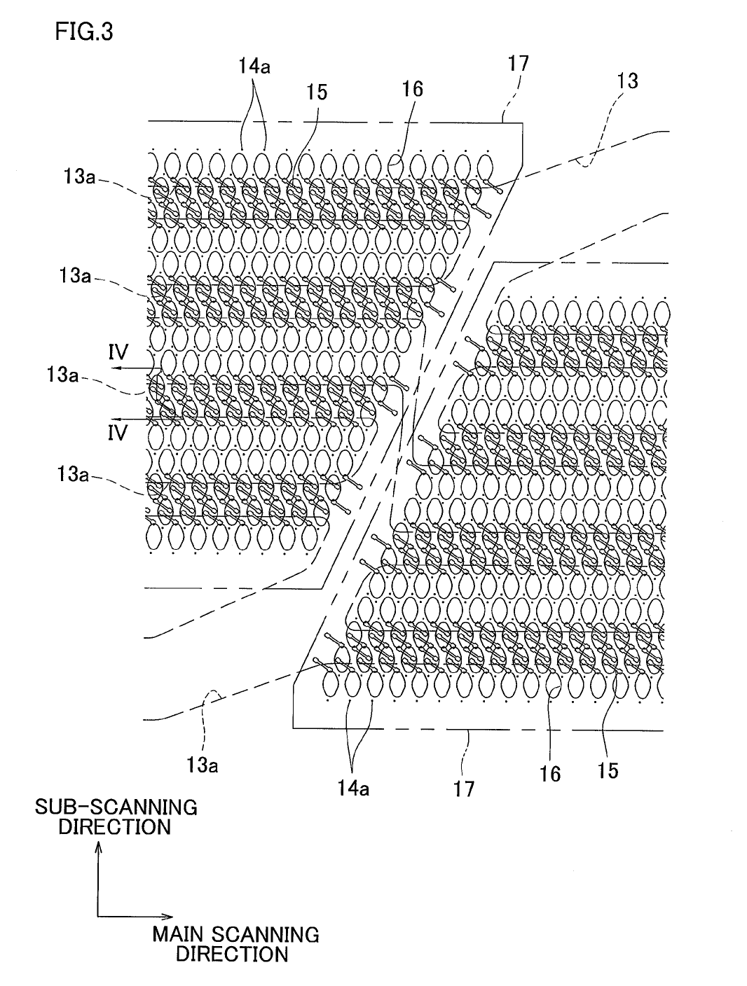

Now, referring to FIG. 2 to FIG. 5, the arrangement of each head 10 will be described. In FIG. 3, the pressure chamber 16 and the aperture 15 are indicated by full lines rather than broken lines, even if they are provided below the actuator unit 17.

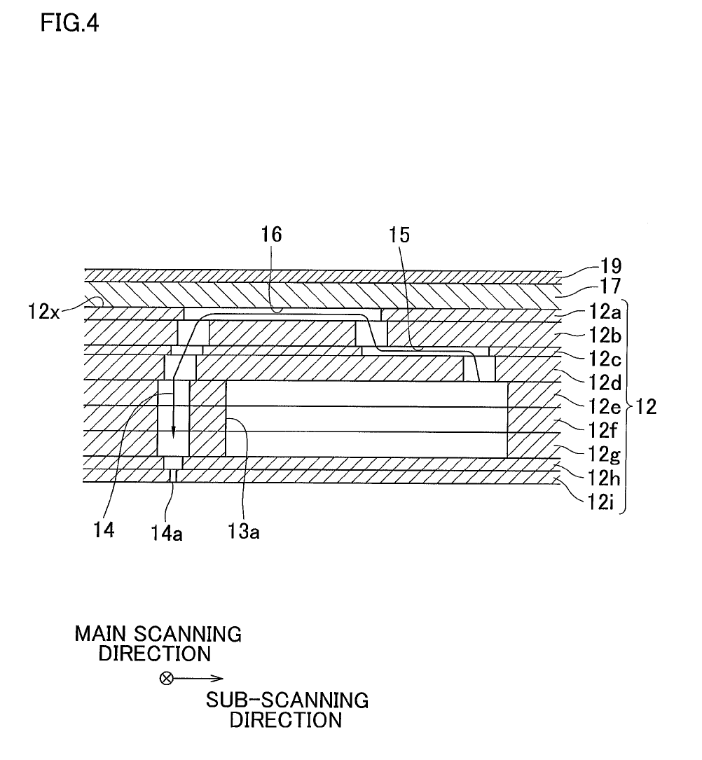

The head 10 is formed by depositing a passage unit 12, actuator units 17, a reservoir unit 11, and a circuit board from bottom up. The reservoir unit 11 as an upstream passage member has an upstream ink passage including a reservoir, which receives ink from the cartridge 39. The reservoir temporarily stores ink. The passage unit 12 as a downstream passage member is, as shown in FIG. 4, formed by depositing nine rectangular metal plates 12a-12i. The passage unit 12 has a downstream ink passage. This downstream ink passage is connected with the upstream ink passage at an opening 12y on the upper surface 12x. The downstream ink passage is constituted by, as shown in FIG. 2 to FIG. 4, a manifold passage 13 whose one end is the opening 12y, a sub-manifold passage 13a branched from the manifold passage 13, and a plurality of individual ink flow passages 14 connected to the sub-manifold passage 13a. Each individual ink flow passage 14 has an aperture 15 for adjusting the passage resistance, and connects the outlet of the sub-manifold passage 13a with the ejection opening 14a via the pressure chamber 16. Through the upper surface 12x, pressure chambers 16 are made in a matrix manner. The lower surface is an ejection surface 10a where the ejection openings 14a are formed.

The actuator units 17 are sandwiched between the reservoir unit 11 and the passage unit 12 and are provided in a staggered manner along the main scanning direction. The actuator units 17 are fixed at the upper surface 12x of the passage unit 12 to seal the opening of each pressure chamber 16. The actuator units 17 are formed by depositing a piezoelectric layer (topmost layer) polarized in the thickness directions onto a diaphragm. The diaphragm is also a piezoelectric layer but does not actively deform. The topmost layer is sandwiched by a plurality of individual electrodes on the surface and a common electrode on the inner side. As a part sandwiched between one individual electrode and the common electrode is deformed, this part and the diaphragm conduct unimorph deformation. The part conducting the unimorph deformation (i.e., the part sandwiched between the individual electrode and the pressure chamber) functions as an individual actuator, and such actuators are selectively driven by a drive signal.

The circuit board is electrically connected to the actuator units 17 by an FPC 19. The FPC 19 is mounted with a driver IC on its part. Under the control of the control unit 1p, the FPC 19 transmits various signals (such as a control signal and an image signal) relayed and adjusted by the circuit board to the driver IC, and transmits a drive signal generated by the driver IC to an individual actuator.

Now, referring to FIG. 5 to FIG. 7, a head holder 3 and a cap 40 and joints 51 attached to the head holder 3 will described.

The head holder 3 is a frame made of metal, which supports the entirety of the side faces of the reservoir unit 11. The head holder 3 is provided for each head 10 and provided with a cap 40 and a pair of joints 51. The pair of joints 51 are, as show in FIG. 5, provided to be adjacent to the respective end portions of the head 10 in the main scanning direction. More specifically, as shown in FIG. 5, the pair of joints 51 are constituted by a left joint 51 having an opening 51a and a right joint 51 having an opening 51b, and these joints 51 are provided to sandwich the reservoir unit 11 in the main scanning direction. The pair of joints 51 are provided to be point symmetric about the center of the head 10. In the humidifying maintenance, humidified air is supplied to the ejection space S1 from the opening 51a, and air is discharged through the opening 51b. The openings 51a and 51b are, as shown in FIG. 5, provided at locations further from the opposing surface 7a than the ejection surface 10a.

The joint 51 has, as shown in FIG. 6A, a square-shaped proximal end portion 51x and a cylindrical leading end portion 51y extending from the proximal end portion 51x. In the joint 51, a cylindrical hollow space 51z is formed so as to extend in the vertical directions from the proximal end portion 51x to the leading end portion 51y. The exterior size of the proximal end portion 51x is larger than that of the leading end portion 51y. The hollow space 51z is equally sized in cross section along the vertical directions. The proximal end portion 51x is long in the sub-scanning direction, and the width (length) in the longitudinal directions thereof is slightly longer than the ejection surface 10a and substantially as long as a pair of horizontal portions 62a and 62b.

The head holder 3 has a through hole 3a which is circular in plan view, and the joint 51 is fixed to the head holder 3 as the leading end portion 51y is inserted into the through hole 3a. The leading end portion 51y is a size smaller than the through hole 3a. The gap therebetween is sealed by a sealing material or the like.

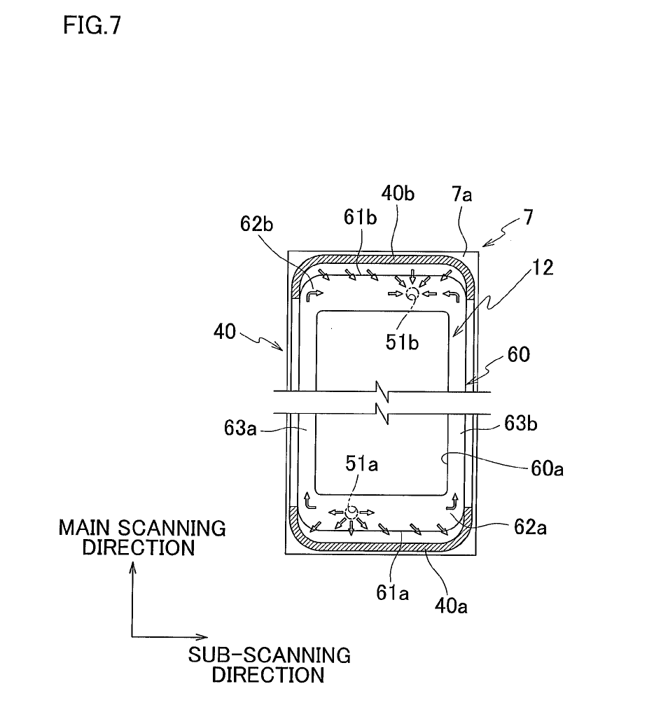

Each cap 40 is, as shown in FIG. 7, a rectangular annular component surrounding the outer circumference of the head 10 in plan view, and is long in the main scanning direction. The cap 40 includes, as shown in FIG. 6A, an elastic member 41 supported by the head holder 3 and an elevatable movable body 42. Furthermore, the cap 40 defines, as shown in FIG. 5 and FIG. 6B, parts of a supply opening 61a and a discharging opening 61b.

The elastic member 41 is made of an annular elastic material such as rubber, and surrounds the head 10 in plan view. The elastic member 41 includes, as shown in FIG. 6A, a base portion 41x, a protrusion 41a protruding downward from the base portion 41x, a fixing component 41c fixed to the head holder 3, and a connecting portion 41d connecting the base portion 41x with the fixing component 41c. Among these components, the protrusion 41a protrudes from the lower surface of the base portion 41x and is triangular in vertical cross section. The fixing component 41c is T-shaped in cross section. The upper end of the fixing component 41c is fixed to the head holder 3 by an adhesive or the like. The fixing component 41c is sandwiched between the head holder 3 and the proximal end portion 51x of each joint 51. The connecting portion 41d curvedly extends from the lower end of the fixing component 41c toward the outside (i.e. in the direction away from the ejection surface 10a in plan view) and is connected to the lower end of the base portion 41x. The connecting portion 41d is deformed in accordance with the vertical movement of the movable body 42. When lowered, the connecting portion 41d defines the supply opening 61a with a later-described horizontal portion 62a, and constitutes the discharging opening 61b with a later-described horizontal portion 62b. On the upper surface of the base portion 41x is formed a concave portion 41b. This concave portion 41b is fitted with the lower end of the movable body 42.

The movable body 42 is made of an annular rigid material (such as stainless steel) and surrounds the outer circumference of the head 10 in plan view. The movable body 42 is supported by the head holder 3 via the elastic member 41 and is arranged to be movable relative to the head holder 3 in the vertical directions. The movable body 42 is connected with a plurality of gears 43 at a plurality of parts. As an elevating motor 44 (see FIG. 8) is driven under the control of the control unit 1p, the gears 43 rotate and the movable body 42 moves up or down. The base portion 41x also moves up or down with the movable body 42. As a result, the relative positions of the leading end 41a1 of the protrusion 41a and the ejection surface 10a are changed in the vertical directions. In the present embodiment, the driving force of the one elevating motor 44 is selectively transmitted to the plurality of gears 43 corresponding to the four caps 40, for one of the caps 40.

As the movable body 42 moves up or down, the protrusion 41a selectively takes either a abutting position (shown in FIG. 6B) where the leading end 41a1 abuts against the opposing surface 7a or a separated position (see FIG. 6A) where the leading end 41a1 is away from the opposing surface 7a. At the abutting position, the ejection space S1 is in a sealed state in which the ejection space S1 is sandwiched between the ejection surface 10a and the opposing surface 7a of the platen 7 so as to be separated from the external space S2. On the other hand, at the separated position, the ejection space S1 is in a non-sealed state in which the ejection space S1 is connected to the external space S2. According to the present embodiment, the caps 40 which are annular components, the transmission mechanism including the gears 43, the head holder 3, the elevating motor 44, and the platen 7 which is an opposing component constitute the capping mechanism.

Now, referring to FIG. 5 to FIG. 7, the structure of the mechanism 50 for supplying humidified air will be described.

The mechanism 50 for supplying humidified air includes, as shown in FIG. 5, a pair of joints 51, a guide member 60, tubes 55 and 57, a pump 56, a water temperature sensor 46, a heater 58, and a tank 54. Each of the tubes 55 and 57 includes main bodies 55a and 57a which are shared by the four heads 10 and four branches 55b and 57b branched from the main bodies 55a and 57a and reach the joints 51. The pump 56 is provided on the main body 57a. FIG. 5 shows a pair of branches 55b and 57b and a single head 10. In actual cases, however, four heads 10 are connected in a parallel manner with a single main body 55a and a single main body 57a via the branches 55b and 57b.

The leading end of the branch 55b of the tube 55 is fitted with the leading end portion 51y of the left joint 51, whereas the other end of the each branch 55b is connected to the tank 54.

On the other hand, the leading end of the branch 57b of the tube 57 is fitted with the leading end 51y of the right joint 51, whereas the other end of the branch 57b is connected to the tank 54.

The tank 54 stores water in its lower space, and also stores, in its upper space, humidified air humidified by the water in the lower space. The tube 57 is connected to the lower space of the tank 54. On the other hand, the tube 55 is connected to the upper space of the tank 54. To prevent the water in the tank 54 from flowing into the pump 56, an unillustrated check valve is attached to the tube 57 to allow the air to flow only in the direction indicated by outlined arrows in FIG. 5. Furthermore, the tank 54 is provided with the water temperature sensor 46 measuring the temperature of the water, and the heater 58 is provided in the vicinity of the tank 54 (lower space) to heat the water in the tank 54. To perform the humidification, the heater 58 is controlled by the control unit 1p based on the result of temperature detection by the water temperature sensor 46, so that the moisture of the humidified air is adjusted. In the present embodiment, the power source of the printer 1 is turned on so that the moisture of the humidified air is automatically adjusted to a desired moisture. When the remaining amount of water in the tank 54 becomes small, water is supplied from an unillustrated supply tank.

As described above, the present embodiment is arranged so that a humidification device for generating humidified air is constituted by components such as a tank 54, a heater 58, and a water temperature sensor 46. Furthermore, a return passage of humidified air is formed by components such as tubes 55 and 57 and a pair of joints 51 in addition to a cap 40 establishing the sealed state. Thanks to the humidification device and the return passage, it is possible to effectively humidify the ejection space S1 during the humidifying maintenance.

In the present embodiment, as shown in FIG. 6B and FIG. 7, a guide member 60 having a lower surface which is flush with the ejection surface 10a and continued from the ejection surface 10a is provided to surround the head 10. The guide member 60 is a rectangular plate member having a through hole at the center. With this through hole, the lower end and its vicinity of the head 10 is fitted. The guide member 60 is constituted by a pair of horizontal portions 62a and 62b extending in the sub-scanning direction and a pair of horizontal portions 63a and 63b extending in the main scanning direction, and the inner circumferential surface 60a of the through hole is bonded with the profile of the passage unit 12. The horizontal portion 62a which is a first guide is provided to oppose the opening 51a of the left joint 51 and defines the supply opening 61a with the connecting portion 41d of the cap 40. The horizontal portion 62b which is a second guide is provided to oppose the opening 51b of the right joint 51 and defines the discharging opening 61b with the connecting portion 41d.

The pair of horizontal portions 62a and 62b are connected to the respective ends of the head 10 in the main scanning direction so as to be adjacent to each other. On the other hand, the pair of the horizontal portions 63a and 63b are connected to the respective ends of the head 10 in the sub-scanning direction so as to be adjacent to each other, so that the pair of the horizontal portions 62a and 62b are connected thereby with each other. Furthermore, the pair of the horizontal portions 63a and 63b are substantially as long as the ejection surface 10a in the main scanning direction. The pair of horizontal portions 62a and 62b are formed to be slightly longer than the ejection surface 10a and substantially as long as the proximal end portion 51x in the sub-scanning direction.

The horizontal portion 62a which is the first guide is, as shown in FIG. 6B, arranged so that the outer upper corner portions thereof in the main scanning direction oppose the inner circumferential surface of the connecting portion 41d extending obliquely downward, with a gap therebetween. This gap extends to reach the both end portions of the horizontal portion 62a in the sub-scanning direction, so as to define the supply opening 61a. At these end portions, the inner circumferential surface of the connecting portion 41d contacts the corner portions of the horizontal portion 62a. The humidified air flows out from the entirety of the long and narrow supply opening 61a. The supply opening 61a is arranged to be open toward the first region 40a of the cap 40. The first region 40a is constituted by the connecting portion 41d and the protrusion 41a, and is a region defined by one short side of the rectangular elastic member 41 and a corner connecting this short side and a long side. The lower shaded region in FIG. 7 is provided around the lower edge of the first region 40a. Because the supply opening 61a is open toward the first region 40a in this manner, the humidified air certainly flows along the inner circumferential surface of the first region 40a as indicated by outlined arrows in FIG. 6B.

By the arrangement above, the present embodiment is arranged so that, when the ejection space S1 is in the sealed state, a humidifying passage is formed so that the humidified air flows along the inner circumferential surfaces of the first region 40a and the second region 40b of the cap 40. This makes it possible to restrain the ink remaining on the cap 40 and its surrounding from being thickened. As a result, the ink in the ejection opening 14a is not easily thickened in the sealed state. Furthermore, since the supply opening 61a is open toward the first region 40a, the humidified air supplied from the supply opening 61a is encouraged to flow along the entirety of the inner circumferential surface of the first region 40a of the cap 40. This further restrains the residual ink adhering to the inner circumferential surface from being thickened.

The arrangement around the horizontal portion 62b which is the second guide is, as shown in FIG. 6B, identical with the arrangement around the horizontal portion 62a. The discharging opening 61b discharges air around the inner circumferential surface of the second region 40b (the upper shaded region in FIG. 7 is provided around the lower edge of the second region 40b) defined by the protrusion 41a and the connecting portion 41d. Because the discharging opening 61b is provided to be adjacent to the second region 40b as above, the air inside the ejection space S1 certainly flows along the inner circumferential surface of the second region 40b as indicated by outline arrows in FIG. 6B. In other words, the air inside the ejection space S1 is encouraged to flow along the entirety of the inner circumferential surface of the second region 40b of the cap 40. It is therefore possible to further restrain the residual ink adhering to the inner circumferential surface from being thickened.

According to the present embodiment, the supply opening 61a and the discharging opening 61b are arranged to circumferentially extend along the inner circumferential surfaces of the first region 40a and the second region 40b, respectively. It is therefore possible to further restrain the residual ink from being thickened.

In addition to the above, according to the present embodiment, the head 10 and the cap 40 are, in plan view, rectangular and the lengths thereof in the main scanning direction are longer than the lengths thereof in the sub-scanning direction, and one short side of the cap 40 is a part of the first region 40a whereas the other short side of the cap 40 is a part of the second region 40b. This further restrains the residual ink from being thickened.

According to the arrangement above, when the humidifying maintenance is conducted, the pump 56 is driven under the control of the control unit 1p so that the humidified air in the tank 54 flows from the tank 54 toward the opening 51a (i.e. in the direction indicated by the outlined arrow in FIG. 5), and hence the humidified air is circulated in the ejection space S1. In other words, as indicated by the outlined arrows in FIG. 6B and FIG. 7, the humidified air flowing vertically downward from the opening 51a collides with the upper surface of the horizontal portion 62a so as to generate a flow along the upper surface, and is further supplied from the supply opening 61a to the ejection space S1 along the connecting portion 41d which is a part of the first region 40a. Thereafter, the humidified air flows toward the second region 40b as the air passes through the gap between the ejection surface 10a having the plurality of ejection openings 14a and the opposing surface 7a and the gap between the pair of horizontal portions 63a and 63b and the opposing surface 7a. At the same time, a part of the humidified air flows above the pair of horizontal portions 63a and 63b and is discharged through the opening 51b. It is therefore possible to humidify the residual ink remaining on this passage.

The humidified air having flown toward the second region 40b flows along the inner circumferential surface of the second region 40b and is discharged through the discharging opening 61b. The discharged air passes through the opening 51b and the tube 57 and flows into the tank 54.

According to the present embodiment, as shown in FIG. 6B, the humidifying passage includes a passage which extends along a first boundary 65a which is the boundary between the first region 40a of the cap 40 and the platen 7 and a second boundary 65b which is the boundary between the second region 40b and the platen 7. Furthermore, the humidifying passage includes a passage which connects the first region 40a and the second region 40b of the cap 40 with each other and extends along the boundary between a region of the cap 40 which region is in parallel to the main scanning direction and the platen 7 (i.e., the portion where the region abuts against the platen 7). In short, all boundaries are parts of the humidifying passage. Since the humidifying maintenance is conducted in this way, a humidifying passage is constructed so that the humidified air flows into every corner of the ejection space 51 and is eventually discharged through the discharging opening 61b. It is noted that, once ink adheres to any part of the leading end 41a1 of the cap 40, the ink spreads along the boundaries including the first and second boundaries 65a and 65b. In this regard, since the humidifying passage includes passages extending along these boundaries, the humidified air supplies moisture to the ink at the boundaries. As such, the thickening of the ink is restrained at the ejection openings 14a adjacent to the boundaries.

Now, referring to FIG. 8, the electric configuration of the printer 1 will be described.

As shown in FIG. 8, the control unit 1p includes, in addition to a CPU (Central Processing Unit) 101 which is a processing unit, a ROM (Read Only Memory) 102, a RAM

(Random Access Memory: including nonvolatile RAM) 103, an ASIC (Application Specific Integrated Circuit) 104, an I/F (Interface) 105, and an I/O (Input/Output Port) 106. The ROM 102 stores programs run by the CPU 101, various types of fixed data, or the like. The RAM 103 temporarily stores data required when a program is run. The ASIC 104 conducts rewriting, reordering (e.g., signal processing and image processing) or the like of image data. The I/F 105 deals with data exchange with an external apparatus. The I/O 106 inputs or outputs detection signals to/from sensors.

The control unit 1p is connected to motors 125 and 127, a sheet sensor 32, a control substrate of the head 10, a water temperature sensor 46, a heater 58, a pump 56, or the like. The control unit 1p is also connected to an elevating motor 44 which drives the gears 43 (see FIG. 6A).

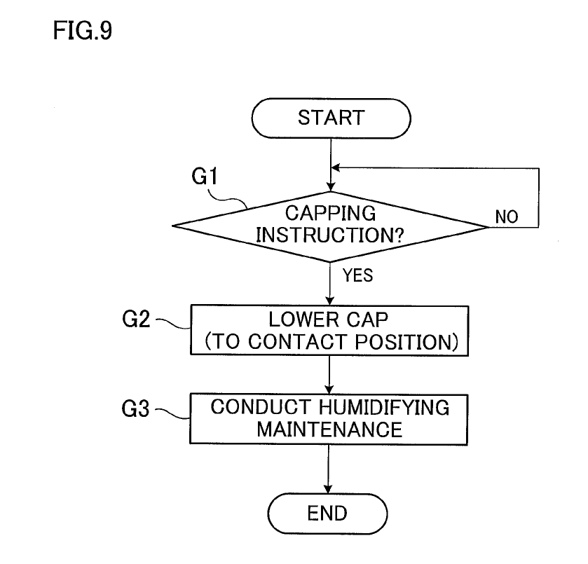

Now, referring to FIG. 9, how the control unit 1p controls the capping and the humidifying maintenance will be detailed.

First, the control unit 1p determines, as shown in FIG. 9, whether a capping instruction has been received (G1). Before receiving the capping instruction, the cap 40 is at the separated position.

Receiving the capping instruction (G1: YES), the control unit 1p drives the elevating motor 44 so as to move each cap 40 from the separated position to the abutting position (G2). As a result, the leading end 41a1 of each cap 40 abuts against the opposing surface 7a and hence the ejection space 51 formed between the ejection surface 10a and the opposing surface 7a of the platen 7 becomes in the sealed state and separated from the external space S2 (see FIG. 5 and FIG. 6B).

After the step G2, the control unit 1p drives the pump 56 to conduct the humidifying maintenance of supplying the humidified air in the tank 54 from the supply opening 61a to the ejection space 51 and discharging the air in the ejection space 51 through the discharging opening 61b, for a predetermined time (G3). With this, the humidified air circulates between the tank 54 and the ejection space 51, with the result that the moisture of the air in the ejection space 51 is adjusted to a desired moisture. In so doing, the humidified air supplied from the supply opening 61a flows along the humidifying passage in the ejection space 51 as described above, and is discharged through the discharging opening 61b. It is therefore possible to supply the moisture to the residual ink and the ink around the ejection openings 14a on the humidifying passage.

As such, the capping and the humidifying maintenance are completed. Thereafter, receiving a signal such as the recording instruction from an external apparatus, the control unit 1p drives the elevating motor 44 so as to move each cap 40 from the abutting position to the separated position. Consequently, the leading end 41a1 of each cap 40 is separated from the opposing surface 7a and a non-sealed state is established, so that the ejection space 51 formed between the ejection surface 10a and the opposing surface 7a of the platen 7 is connected to the external space S2 (see FIG. 1). Thereafter, the recording operation is conducted under the control of the control unit 1p as described above.

As described above, the printer 1 of the present embodiment is arranged so that, in the humidifying maintenance, the humidified air flows along the inner circumferential surfaces of the first region 40a and the second region 40b of the cap 40 which is an annular component. For this reason, even if, for example, ink remains on the cap 40 and its surroundings (e.g. at the boundary between the cap 40 and the platen 7) as a result of the preliminary ejection, it is possible to supply moisture to such residual ink. It is therefore possible to restrain the thickening of the residual ink after the humidifying maintenance has been conducted and the sealed state continues, and therefore the ink in the ejection openings 14a is not easily thickened.

In addition to the above, since the pair of horizontal portions 62a and 62b are provided as first and second guides to constitute the supply opening 61a and the discharging opening 61b, the thickening of the ink on the inner circumferential surfaces of the second regions 40a and 40b, where ink is likely to remain, is certainly prevented.

Now, variations of the embodiment above will be described. According to the first variation, humidified air is supplied from the platen 7 into the ejection space S1. More specifically, as shown in FIG. 10, two openings 251a and 251b are provided on the platen 7 to sandwich the ejection surface 10a in the main scanning direction. The opening 251a is connected to the branch 55b of the tube 55, and the humidified air is supplied into the ejection space S1 therethrough. On the other hand, the opening 251b is connected to the branch 57b of the tube 57, and the air in the ejection space S1 is discharged therethrough. To cover the opening 251a and the opening 251b, respectively, guide members 262a and 262b are provided to sandwich the sheet conveying passage in the main scanning direction. Each of these guide members 262a and 262b is L-shaped in cross section and is fixed to the opposing surface 7a.

The guide member 262a which is the first guide defines the supply opening 261a with the opposing surface 7a and is open toward the first region 40a. With this, the humidified air from the opening 251a is also supplied toward the first region 40a. The guide member 262b as the second guide defines the discharging opening 261b with the opposing surface 7a and is open toward the second region 40b. For this reason, the air in the ejection space S1 flows along the second region 40b and then certainly discharged through the discharging opening 261b.

Also in this first variation, in the humidifying maintenance, the humidified air supplied from the supply opening 261a flows, as shown in an arrow in FIG. 10, along the inner circumferential surface of the first region 40a, passes through the gap between the ejection surface 10a and the opposing surface 7a, flows along the inner circumferential surface of the second region 40b, and is discharged through the discharging opening 261b. Such a humidifying passage is formed in the ejection space 51. With this, the effects similar to those of the embodiment above are achieved. In the variation, furthermore, each head 10 is not provided with a joint 51 or the like, because the humidified air is supplied and discharged from/through the platen 7.

A second variation described below is arranged so that a capping mechanism different from the above-described capping mechanism is used. In this case, the capping mechanism includes, as shown in FIG. 11, a cap 340 and a moving mechanism (not illustrated) which moves the cap 340 between an opposing position where the cap 340 opposes the ejection surface 10a and a non-opposing position where the cap 340 does not oppose the ejection surface 10a.

The cap 340 includes a flat-plate-shaped opposing member 307 opposing the ejection surface 10a and an annular lip 308 standing on the periphery of the opposing member 307, so as to form a concave portion arranged to be open toward the ejection surface 10a. The lip 308 is arranged to oppose the periphery of the ejection surface 10a when the cap 340 is at the opposing position. The opposing member 307 is provided with two openings 351a and 351b which are remote from each other in the main scanning direction. The opening 351a is connected to the branch 55b of the tube 55 to supply the humidified air in the humidifying maintenance. On the other hand, the opening 351b is connected to the branch 57b of the tube 57 to discharge the air in the ejection space S1 in the humidifying maintenance. On the upper surface (opposing surface) 307a of the opposing member 307 opposing the ejection surface 10a, guide members 362a and 362b are fixed as the first and second guides in the same manner as the first variation, so that the supply opening 361a and the discharging opening 361b are defined.

The supply opening 361a is arranged to be open toward one end portion (i.e., the first region 340a which is a part of the lip 308) of the cap 340 in the main scanning direction. The humidified air is therefore supplied toward the first region 340a. The discharging opening 361b is arranged to be open toward the other end portion (i.e., the second region 340b which is a part of the lip 308) of the cap 340 and to be in proximity to the second region 340b. It is therefore possible to cause the air in the ejection space S1 to flow along the second region 340b and then to be certainly discharged through the discharging opening 361b.

The moving mechanism moves up or down the cap 340 when the cap 340 is at the opposing position (i.e., when the cap 340 is at a position between the abutting position where the lip 308 abuts against the ejection surface 10a and the separated position where the lip 308 and the ejection surface 10a are separated). With this, the capping mechanism causes the ejection space S1 to take either a sealed state where the ejection space S1 is separated from the external space S2 or a non-sealed state where the ejection space S1 is connected to the external space S2. The lip 308 surrounds the ejection space S1 in the sealed state. In this variation, furthermore, a joint 51 or the like is not provided in each head 10 because the humidified air is supplied from and discharged through the opposing member 307.

According to the second variation, the humidified air supplied from the supply opening 361a flows, as indicated by arrows in FIG. 11, along the inner circumferential surface of the first region 340a. Thereafter, the humidified air flows along the boundary of the ejection surface 10a and the lip 308 (i.e., at the leading end of the lip 308) and along the ejection surface 10a, passes through the gap between the ejection surface 10a where the plurality of ejection openings 14a are formed and the opposing surface 307a, flows along the inner circumferential surface of the second region 340b, and is eventually discharged through the discharging opening 361b. In the humidifying maintenance of the variation, such a humidifying passage is formed in the ejection space S1. The effects similar to those of the embodiment above are therefore achieved. Furthermore, the humidifying passage in the humidifying maintenance includes a passage along the boundary between the ejection surface 10a and the lip 308. Since the humidified air flows along the boundary where ink is likely to remain, it is possible to supply moisture to the ink at the boundary. The thickening of the residual ink is therefore restrained and the thickening of the ink at the ejection openings 14a adjacent to the boundary is also restrained.

In addition to the above, as shown in FIG. 11, the humidifying passage includes a passage extending along the first boundary 365a which is a boundary between the first region 340a which is a part of the lip 308 of the cap 340 and the opposing member 307 and along the second boundary 365b which is a boundary between the second region 340b which is a part of the lip 308 and the opposing member 307. Since this makes it possible to supply moisture to the ink remaining at the boundaries 365a and 365b, it is possible to restrain such residual ink from being thickened. As a matter of course, the effects similar to those of the embodiment above are achieved.

In the second variation, an annular plate-shaped component having a lower surface provided at the same height as the ejection surface 10a lower surface may be fixed to the outer side faces of the head 10 to surround the head 10 so that the lower surface of the plate-shaped component abuts against the lip 308. In other words, the lip 308 may be arranged not to abut against the ejection surface 10a but to abut against the plate-shaped component on the outer circumference. The effects similar to the above are achievable with this arrangement.

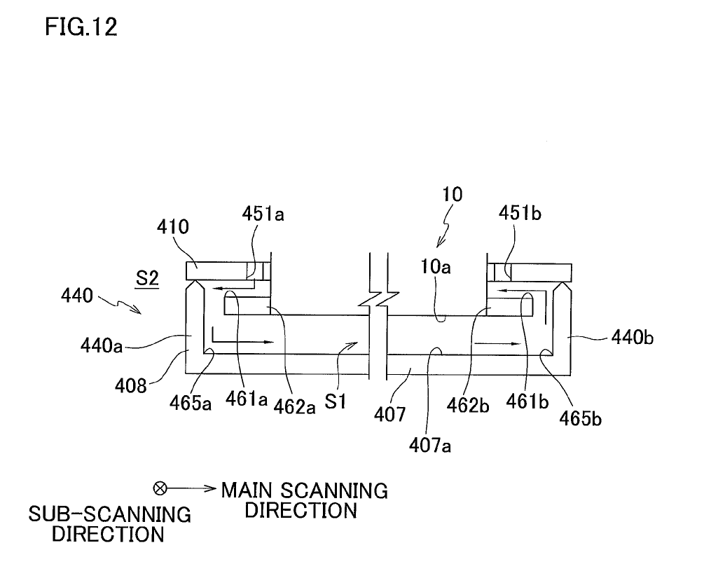

A third variation described below uses a further capping mechanism. In this case, the capping mechanism includes, as shown in FIG. 12, a cap 440 and a moving mechanism (not illustrated) which moves the cap 440 between an opposing position where the cap 440 opposes the ejection surface 10a and a non-opposing position where the cap 440 does not oppose the ejection surface 10a.

The cap 440 includes a flat-plate-shaped opposing member 407 opposing the ejection surface 10a and an annular lip 408 standing on the periphery of the opposing member 407, so as to form a concave portion which is open toward the ejection surface 10a. The lip 408 is formed to oppose the periphery of a later-described plate-shaped component 410 when the cap 440 is at the opposing position. The moving mechanism moves up or down the cap 440 when the cap 440 is at the opposing position (i.e., when the cap 440 is at a position between a abutting position where the lip 408 abuts against the plate-shaped component 410 and a separated position where the lip 408 is separated from the plate-shaped component 410). With this, the capping mechanism causes the ejection space S1 to take either a sealed state where the ejection space S1 is separated from the external space S2 or a non-sealed state where the ejection space S1 is connected to the external space S2. The lip 408 surrounds the ejection space S1 in the sealed state.

To the outer profile of the head 10, an annular plate-shaped component 410 is fixed to surround the head 10. The plate-shaped component 410 has two openings 451a and 451b which are arranged to sandwich the head 10 in the main scanning direction. The opening 451a is connected to the branch 55b of the tube 55 to supply humidified air in the humidifying maintenance. On the other hand, the opening 451b is connected to the branch 57b of the tube 57 to discharge the air in the ejection space S1 in the humidifying maintenance.

In addition to the above, below the plate-shaped component 410 on the profile of the head 10 in the main scanning direction, plate-shaped guide members 462a and 462b are fixed as first and second guides to fulfill the same function as the horizontal portions 62a and 62b above. These guide members 462a and 462b are substantially as wide as the ejection surface 10a in the sub-scanning direction. Furthermore, the guide member 462a opposes one end portion of the cap 440 in the main scanning direction (i.e. a first region 440a which is a part of the lip 408) with a gap interposed therebetween, so as to define a supply opening 461a. The supply opening 461a is narrow and long in the sub-scanning direction. With this, the humidified air from the opening 451a is supplied from the supply opening 461a toward the entirety of the first region 440a. Furthermore, the guide member 462b opposes the other end portion of the cap 440 in the main scanning direction (i.e., a second region 440b which is a part of the lip 408) with a gap interposed therebetween, so as to define a discharging opening 461b. This discharging opening 461b is also narrow and long in the sub-scanning direction. This makes it possible to cause the air in the ejection space S1 to flow along the entirety of the second region 440b and then to be discharged.

Also in this third variation, in the humidifying maintenance, the humidified air supplied from the supply opening 461a flows, as indicated by arrows in FIG. 12, along the inner circumferential surface of the first region 440a, passes through the gap between the ejection surface 10a on which the plurality of ejection openings 14a are formed and the opposing surface 407a, flows along the inner circumferential surface of the second region 440b, and is eventually discharged through the discharging opening 461b. Such a humidifying passage is formed in the ejection space S1. This makes it possible to achieve the effects similar to those of the embodiment above. Furthermore, as shown in FIG. 12, the humidifying passage includes a passage which extends along the first boundary 465a which is a boundary between the first region 440a which is a part of the lip 408 of the cap 440 and the opposing member 407 and along the second boundary 465b which is a boundary between the second region 440b which is a part of the lip 408 and the opposing member 407. This makes it possible to supply moisture also to the ink remaining at the boundaries 465a and 465b, and hence the thickening of such residual ink is restrained. As a matter of course, the effects similar to those of the embodiment above are achieved.

Other variations will be described below. While in the embodiment and the variations above the pair of horizontal portions 62a and 62b as the first and second guides and the guide members 262a and 262b, 362a, 362b, 462a and 462b are provided to constitute the supply opening and the discharging opening, these components may be unnecessary. In this case, for example, the opening 51a is formed to be open toward the first region 40a as the supply opening, and the opening 51b is formed to be open toward the second region 40b and to be in proximity to the second region 40b. In other words, the supply opening and the discharging opening are provided to constitute a humidifying passage in which the humidified air flows along the inner circumferential surface of the first region 40a, 340a, 440a, passes through the gap between the ejection opening 14a and the opposing member 7, 307, 407, and flows along the inner circumferential surface of the second region 40b, 340b, 440b. Furthermore, the supply opening and the discharging opening may be formed on the ejection surface 10a. In this case, the supply opening and the discharging opening are preferably formed on the outer side of the region where the ejection openings 14a are formed on the ejection surface 10a, with respect to one direction (e.g., in the main scanning direction). In this regard, the supply opening is formed so that the humidified air is supplied toward the first region 40a whereas the discharging opening is formed so that the air in the ejection space S1 flows along the inner circumferential surface of the second region 40b and is then discharged.

The supply opening 61a is arranged to oppose a part of the first region 40a. The discharging opening 61b is arranged to oppose a part of the second region 40b. The supply opening 61a and the discharging opening 61b are therefore not required to extend along the inner circumferential surfaces of the first region 40a and the second region 40b. Furthermore, the first region and the second region of the cap 40, 340, 440 may be arranged to oppose each other in the horizontal directions that are orthogonal to the main scanning direction. In this case, both of the supply opening and the discharging opening are preferably disposed along the horizontal directions.

In addition to the above, while the embodiment above is arranged so that the capping operation starts first and then the humidifying maintenance operation starts after the sealed state is established, the capping operation and the humidifying maintenance operation may simultaneously start or the humidifying maintenance operation may start before the start of the capping operation. In other words, various arrangements may be used as long as the above-described humidifying passage is formed in the ejection space S1 separated from the external space S2.

The disclosed technology may be used not only for the above-described line-type apparatus but also for serial-type liquid ejection apparatuses. Furthermore, the technology may be used not only for printers but also facsimile machines, photocopiers, and liquid ejection apparatuses that perform recording by ejecting liquid other than ink. The recording medium is not limited to the sheet P, and various recordable media may be used.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A liquid ejection apparatus comprising:
a liquid ejection head having ejection openings for ejecting liquid;
a capping mechanism which causes an ejection space opposing the ejection openings to take either one of a sealed state in which the ejection space is separated from an external space and a non-sealed state in which the ejection space is connected to the external space, the capping mechanism including an annular component which surrounds the ejection space in the sealed state and an opposing member which opposes the ejection openings with the ejection space interposed therebetween;
a mechanism for supplying humidified air, which generates humidified air and includes a supply opening through which the humidified air is supplied into the ejection space separated from the external space by the capping mechanism and a discharging opening through which air is discharged from the ejection space; and
a control unit which controls the capping mechanism so that the ejection space takes either one of the sealed state and the non-sealed state and controls the mechanism for supplying humidified air so that the humidified air is supplied to the ejection space in the sealed state through the supply opening and the humidified air is discharged through the discharging opening,
the supply opening and the discharging opening being positioned to form a humidifying passage such that the humidified air having flown along an inner circumferential surface of a first region of the annular component passes through a gap between the ejection openings and the opposing member and flows along an inner circumferential surface of a second region of the annular component, which opposes the first region.

2. The liquid ejection apparatus according to claim 1, wherein,
the liquid ejection head has an ejection surface where the ejection openings are made through,
the annular component separates, in the sealed state, the ejection space from the external space by abutting against either one of the ejection surface and the opposing member, and
the humidifying passage includes a passage extending along a boundary between the annular component and said one of the ejection surface and the opposing member.

3. The liquid ejection apparatus according to claim 1, wherein,
the supply opening is arranged to be open toward the first region of the annular component, and
the discharging opening is disposed to be in proximity to the second region of the annular component.

4. The liquid ejection apparatus according to claim 3, wherein,
the supply opening circumferentially extends along the inner circumferential surface of the first region of the annular component.

5. The liquid ejection apparatus according to claim 4, wherein,
in plan view, each of the liquid ejection head and the annular component is rectangular and arranged so that sides along one direction are longer than sides along a direction orthogonal to said one direction, and
one of short sides of the annular component is a part of the first region.

6. The liquid ejection apparatus according to claim 3, wherein,
the discharging opening circumferentially extends along the inner circumferential surface of the second region of the annular component.

7. The liquid ejection apparatus according to claim 6, wherein,
in plan view, each of the liquid ejection head and the annular component is rectangular and arranged so that sides along one direction are longer than sides along a direction orthogonal to said one direction, and
one of short sides of the annular component is a part of the second region.

8. The liquid ejection apparatus according to claim 1, wherein,
the supply opening and the discharging opening are provided to sandwich the liquid ejection head,
the annular component encloses the supply opening and the discharging opening in plan view and establishes the sealed state such that a leading end of the annular component abuts against the opposing member, and
the humidifying passage includes a passage extending along a first boundary which is a boundary between the first region of the annular component and the opposing member and along a second boundary which is a boundary between the second region of the annular component and the opposing member.

9. The liquid ejection apparatus according to claim 1, further comprising:
a first guide which constitutes the supply opening which is open toward the inner circumferential surface of the first region so that the humidified air is supplied toward the inner circumferential surface of the first region; and
a second guide which constitutes the discharging opening which is open toward the inner circumferential surface of the second region so that air around the inner circumferential surface of the second region is discharged.

10. The liquid ejection apparatus according to claim 1, wherein,
the mechanism for supplying humidified air includes:
a return passage which has the supply opening at one end and the discharging opening at the other end; and a humidification device which humidifies air in the return passage so as to generate the humidified air.
